(19) United States
(12) Patent Application Publication
(10) Pub. No.: US 2018/0319081 A1
(43) Pub. Date: Nov. 8, 2018

(54) REMOVABLE BUILD MODULES FOR ADDITIVE FABRICATION

(71) Applicant: Formlabs Inc., Somerville, MA (US)

(72) Inventors: Eduardo Torrealba, Cambridge, MA (US); Luke Plummer, Belmont, MA (US); Brian Chan, Cambridge, MA (US); Maxim Lobovsky, Cambridge, MA (US); Shane Wighton, Cambridge, MA (US); Ian Ferguson, Cambridge, MA (US)

(73) Assignee: Formlabs, Inc., Somerville, MA (US)

(21) Appl. No.: 15/970,283

(22) Filed: May 3, 2018

Related U.S. Application Data
(60) Provisional application No. 62/502,569, filed on May 5, 2017.

(51) Int. Cl. B29C 64/259; B29C 64/153; B29C 64/393; B33Y 30/00

(52) U.S. Cl. CPC B29C 64/259; B29C 64/153; B29C 64/218; B33Y 30/00; B29C 64/393

(57) ABSTRACT

Techniques for producing removable build modules for additive fabrication devices are described. According to some aspects, a removable build module may comprise an enclosure having an open top, a fabrication platform arranged in an interior of the enclosure, and at least one actuator incorporated into the enclosure and configured to move the fabrication platform towards and away from the open top of the enclosure.

### CROSS-REFERENCE TO RELATED APPLICATIONS

The present application claims the benefit under 35 U.S.C. § 119(e) of U.S. Provisional Patent Application No. 62/502,569, filed May 5, 2017, titled “Selective-Laser Sintering Techniques and Related Systems and Methods,” which is hereby incorporated by reference in its entirety.

### FIELD OF INVENTION

The present invention relates generally to systems and methods for additive fabrication, e.g., 3-dimensional printing.

### BACKGROUND

Additive fabrication, e.g., 3-dimensional (3D) printing, provides techniques for fabricating objects, typically by causing portions of a building material to solidify at specific locations. Additive fabrication techniques may include stereolithography, selective or fused deposition modeling, direct composite manufacturing, laminated object manufacturing, selective phase area deposition, multi-phase jet solidification, ballistic particle manufacturing, particle deposition, laser sintering or combinations thereof. Many additive fabrication techniques build parts by forming successive layers, which are typically cross-sections of the desired object. Typically each layer is formed such that it adheres to either a previously formed layer or a substrate upon which the object is built. In one approach to additive fabrication, known as selective laser sintering or SLS, solid objects are created by successively forming thin layers by selectively fusing together powdered material. An illustrative description of selective laser sintering may be found in U.S. Pat. No. 4,863,538, incorporated herein in its entirety by reference.

### SUMMARY

According to some aspects, a removable build module is provided for an additive fabrication device configured to fabricate objects by forming layers of solid material from a source material, the removable build module comprising an enclosure having an open top, a fabrication platform arranged in an interior of the enclosure, and at least one actuator incorporated into the enclosure and configured to move the fabrication platform towards and away from the open top of the enclosure.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is an illustrative depiction of selective laser sintering, according to some embodiments; and

FIGS. 2A and 2B depict an illustrative build module, according to some embodiments.

### DETAILED DESCRIPTION

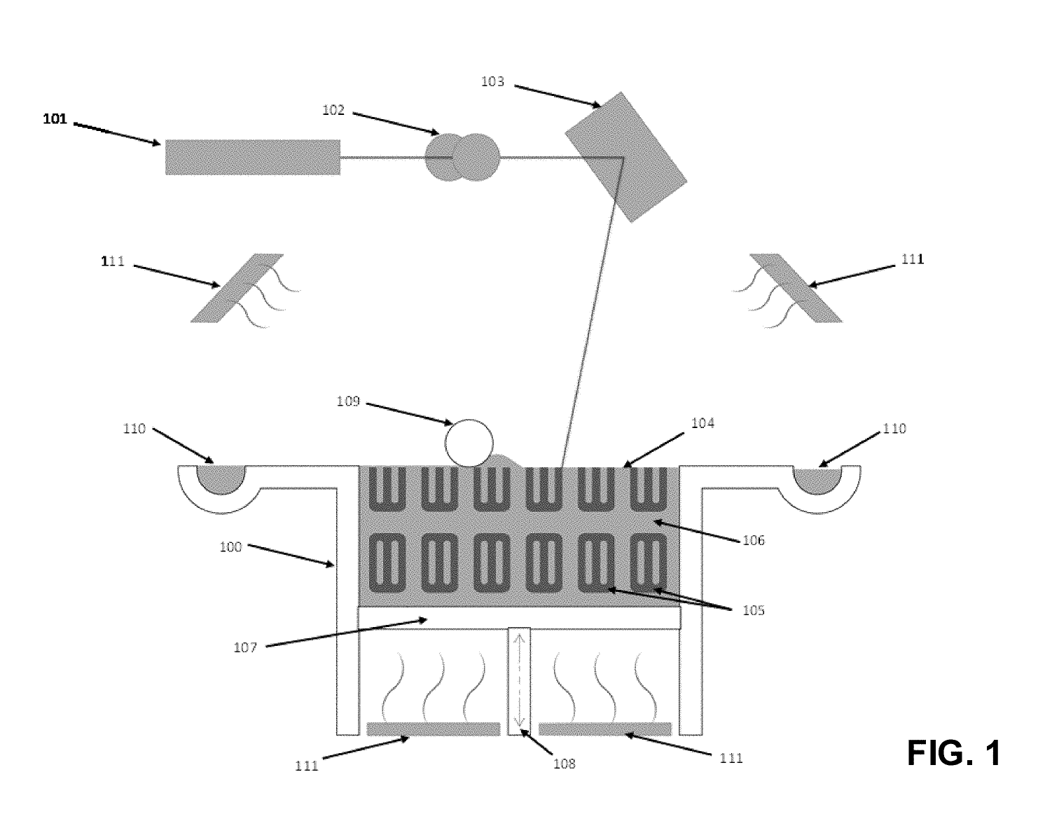

An illustrative system embodying certain aspects of the present invention is depicted in FIG. 1. The illustrated selective laser sintering system comprises a laser or other energy source 101 that is focused and guided through lenses and/or filters 102. The focused energy is paired with a computer-controlled scanner system 103 that may be operated to aim the focused energy at the fabrication powder bed 104 and move over an area of the bed to produce solid material for one or more objects 105, as described below. The area to which the focused energy is directed corresponds to a cross-section of an object to be formed. A series of such cross-sections may be determined from a computer aided design (CAD) model of the object, and by forming solid material according to these cross-sections, the object may be fabricated from a plurality of layers.

The focused energy (presumed to be a laser beam henceforth) may be directed by any form of scanning systems 103, including but not limited to mechanical gantries, linear scanning devices using polygonal mirrors, and/or galvanometer-based scanning devices. The material 106 in the fabrication powder bed 104 is selectively heated by the laser, and/or other source(s) of focusable energy, in a manner that causes the powder material particles to fuse into solid material. As discussed above, the solid material may represent a cross-sectional layer of an object 105 being fabricated. This process of fusing powder into solid material is sometimes also referred to as consolidation. A variety of suitable materials may be used as a source material of this fusing process, including various forms of powdered nylon materials.

Once a current layer has been successfully sintered, the fabrication platform 107 on which the object is being fabricated may be lowered a predetermined distance by a motion system 108. Once the fabrication platform 107 has been lowered, a material deposition mechanism 109 may be moved across the fabrication powder bed 104, spreading a fresh layer of material 106 across the fabrication bed 104 to be sintered as described above. Various mechanisms may apply a consistent layer of material onto the fabrication bed, such as wipers, rollers, blades, and/or other levelling mechanisms to move material from a source of fresh material. In the example of FIG. 1, a roller is pictured pushing powder from the powder delivery area 110 onto the fabrication powder bed 104.

Since material in the fabrication powder bed 104 is generally consolidated in only certain locations by the laser, the remaining material remains in the layer in an unconsolidated state 106. This unconsolidated material is often referred to as the “part cake” 106. In some embodiments, a part cake may physically support features of the object being fabricated, such as overhangs and/or thin walls, during the formation process, allowing for SLS systems to avoid the use of temporary mechanical support structures, which may be used in other additive manufacturing techniques such as stereolithography or fused deposition modeling. In addition, physical support supplied by unconsolidated material may enable parts with more complicated geometries, such as moveable joints or other isolated features, to be printed with interlocking but unconnected components.

The above-described process of consolidation may be repeated, thereby forming the object(s) 105 layer-by-layer until the entire object(s) 105 have been fabricated. Once the object(s) 105 have been fully formed by the method described above, the object(s) 105 and the part cake 106 may be cooled. Cooling may be performed at ambient temperatures, at a fast rate, or at a controlled rate so as to limit issues that may arise with comparatively faster cooling. The object and part cake may be cooled while within the selective laser sintering apparatus, or removed from the apparatus after fabrication to continue cooling. Once cooled, the object can be separated from the part cake by a variety of methods. The unused material in the part cake may optionally be recycled for use in subsequent prints.

In some instances it may be possible to raise the powdered material to its consolidation temperature by exposure to a laser or other focusable energy source 101 alone. In general, however, it may be preferred that the material layer be maintained at an elevated temperature, low enough to minimize thermal degradation, but high enough to require minimal additional energy exposure to trigger consolidation. Maintaining such an elevated temperature, sometimes known as “preheating,” poses numerous technical challenges, however. In some embodiments it may be favorable to include heating elements 111 in strategic locations around the build volume to preheat and maintain temperature.

In many cases, consistency of the temperature of the unconsolidated material may be critical to the successful fabrication of parts using the selective sintering process, both over the full area to be exposed by the focused energy source and over an extended time period as additional exposures are completed. In particular, the system should preferably maintain the temperature of the consolidating material at or above its consolidation temperature for sufficient time for the consolidation process to complete. And, once the focused energy source 101 brings the powdered material 106 in the fabrication bed 104 to a temperature at or above the consolidation temperature, the system preferably maintains such a temperature in the required areas until the particles are able to fuse with their neighboring particles. In particular, these particles bind both to the other particles in their layer that are freshly melted or transitioned as well as the particles that may be above and below as the particles begin to cool. Additionally, the system would preferably maintain the temperature of the unconsolidated material at as close to a constant temperature as may be arranged, in order to ensure that the total amount of energy delivered to an area of unconsolidated material may be determined or be consistent for a given amount of focused energy exposed onto the unconsolidated material. Various techniques for preheating powdered material may be applied, including heating the material via radiative, conductive, or convective heating methods achievable through a variety of heating elements 111.

As illustrated in FIG. 1, selective laser sintering devices may comprise a volume, referred to herein as the fabrication chamber 100, in which unconsolidated powder is deposited and exposed to laser light in order to form the object being fabricated. The region of the fabrication chamber on which the unconsolidated powder is deposited is referred to herein as the fabrication powder bed.

While the side walls of a fabrication chamber may typically be stationary during the fabrication process, at least part of the bottom of the chamber is typically capable of being raised and lowered 108, while remaining in close contact with the sides of the chamber. In particular, this movable element, referred to herein as the fabrication piston 108, is typically lowered a preset distance for each new layer in order to allow additional powder to be spread in a new layer onto the top of previously deposited and potentially consolidated material. Various shapes of fabrication chambers and fabrication pistons are possible, including cylindrical side walls with a circular piston or rectangular prism side walls with a rectangular piston. In some systems, the fabrication chamber may be fixed or otherwise integrated into the overall fabrication device, such that removing it would require substantial effort and partial disassembly of the fabrication device. In some other systems, however, certain advantages may be obtained if the user were able to remove the fabrication powder bed from the fabrication device following the fabrication of a part. In some systems, this may be achieved by making the fabrication chamber removable from the fabrication device.

Conventional fabrication systems utilizing interchangeable fabrication chambers may be designed so as to avoid locating the various mechanisms of the fabrication system within the interchangeable fabrication chamber. For example, mechanisms to couple a fabrication piston to a source of linear motion would conventionally be permanently located within the fabrication system, and not within an interchangeable fabrication chamber. As a result, conventional interchangeable fabrication chambers have typically been comprised of passive mechanical components. Those of skill in the art have typically understood such a configuration to be advantageous in reducing the cost and complexity of the removable components of the system.

The inventors have recognized and appreciated, however, that contrary to the conventional understanding, certain advantages may be obtained by integrating additional functionality into the interchangeable fabrication chamber. In particular, the inventors have recognized that interchangeable fabrication chambers relying upon motion systems located within the fabrication system (and not within the fabrication chamber) may be difficult to secure and operate with the necessary positional precision and accuracy. For example, small changes in the expected position of a coupling system may result in significant process degradation or even failure of the print process, and thus require lengthy calibration procedures or precise dimensional tolerances to rectify. In contrast, embodiments of the present application may incorporate various linear motion systems into the interchangeable fabrication chamber, rather than into the fabrication system outside of the chamber, such that the linear motion system remains integrated with the other components of the fabrication chamber, including the fabrication piston. Such interchangeable fabrication chambers incorporating motion systems are referred to herein as fabrication or build modules.

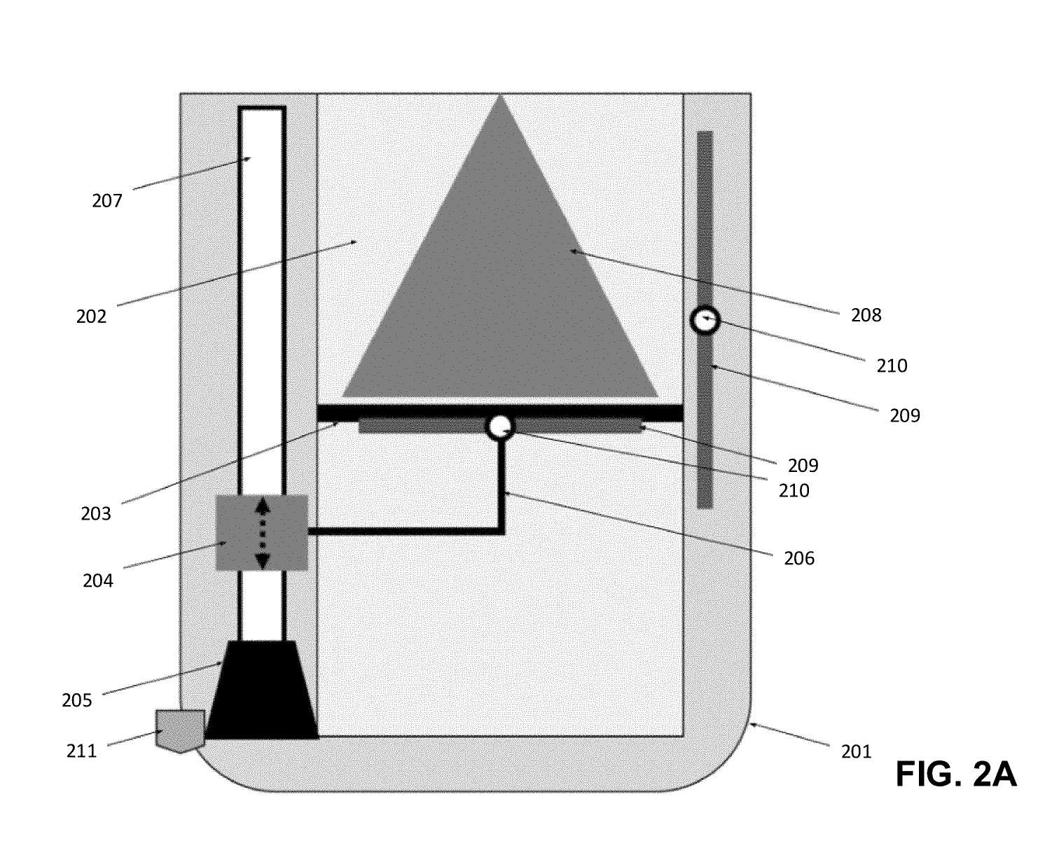

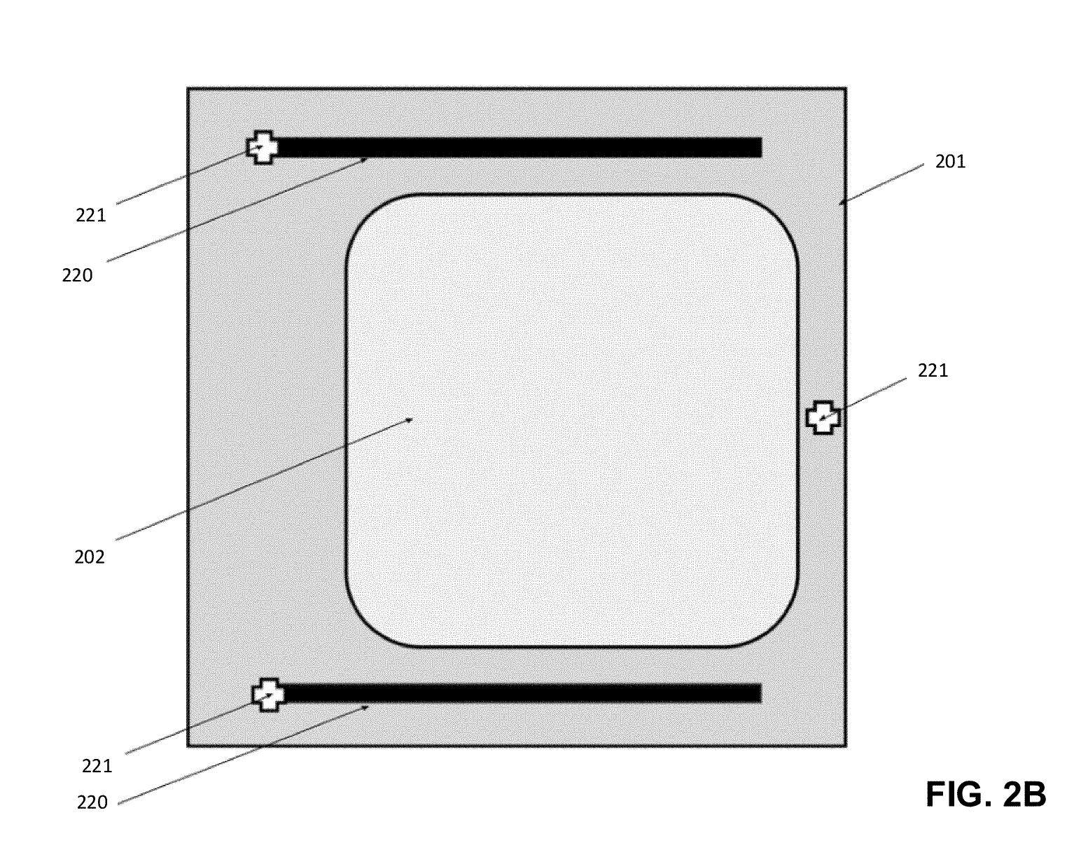

An illustrative embodiment of a build module is depicted in FIGS. 2A and 2B, according to some embodiments. As shown in FIG. 2A, the build module 201 includes a source of motion 205 located within the build module 201. Said motion source 205 may be coupled to the fabrication platform 203 in various ways in order to cause the desired motion of the fabrication platform 203 during operation. In some embodiments, such as the illustrative embodiment shown in FIG. 2A, this source of motion 205 may be a source of rotation such as a stepper or servo motor driving the rotation of a lead screw 207 that causes a lead screw nut 204 to move along the axis of the lead screw 207, lifting the attached arm 206 and fabrication platform 203 to a desired location within the fabrication chamber.

In some embodiments, one or more sensors may be incorporated into the build module and configured to monitor the position of the fabrication platform 203 and/or components in the mechanical linkages supporting said platform (which may, for instance, include a piston as in the example of FIG. 1). As an example, lead screws and stepper motors may provide for effective open-loop control of the motion system 204, but may be further improved by incorporating positional information into a suitable closed-loop control scheme. Alternatively, or in addition to various methods of continually monitoring the position of the moving elements, it may be advantageous to incorporate various fixed contact sensors, such as motion limit switches, to detect when moving components have reached preset positions, such as desired upper or lower limits to the range of motion of the fabrication platform 203.

In some embodiments, the build module may comprise structural features, such as one or more guiding rails or bearings, arranged to limit torsional and other unwanted degrees of freedom in the system, so as to ensure that the fabrication platform 203 remains level as it moves through the fabrication chamber 202. In the case of using two or more guiding rails or other structural features, such features may, in some embodiments, be located symmetrically around the motion system or all to one side of the motion system. As may be appreciated, guide rails may provide additional stability.

Various mechanical systems, in addition to the example provided, may be configured cause the fabrication platform to move within the fabrication device, including belt systems, rack and pinion, hydraulic or pneumatic cylinders, and/or other forms of linear actuators. By incorporating any such system into the interchangeable fabrication chamber 202, rather than into the fixed fabrication system, the resulting coupling may advantageously allow the components of both the mechanical system for moving the fabrication platform and the fabrication chamber to remain calibrated with respect to each other. This static relationship does not depend upon the geometry or method by which the interchangeable fabrication chamber may be attached or secured to the fabrication system, and thus allows for a more consistent and level fabrication bed 104 across multiple insertions of the build module, without requiring additional per-insertion calibration steps.

With the build module 201 being removable from the machine, the object being fabricated may be cooled, processed, and removed from the fabrication chamber outside of the selective laser sintering apparatus, allowing for the fabrication of additional objects by the machine while the object is cooling. In some embodiments it may be advantageous to minimize the electrical components in the removable build module 201 and thereby excluding heating elements 209 from the removable build module.

In some embodiments, the build module 201 may comprise one or more heating elements 209 and/or temperature sensors 210, which are positioned to regulate and/or measure the temperature within the fabrication chamber. Various forms of heating and sensing elements may be used including conductive, radiative, and convective elements.

In some embodiments, the heating element 209 may be a conductive heating element using resistive or non-electric heating mechanisms. In some embodiments, temperature sensor 210 may be chosen from any suitable temperature sensors such as by way of example, infrared temperature sensors, thermistors, thermocouples, resistance temperature detectors (RTDs), or diode temperature sensors.

In some embodiments, the heating element 209 may comprise, or be composed of, a convective heating element such as a forced convective heater with circulation facilitated by a fan or pump. Build modules incorporating such integrated heating and sensing elements may advantageously allow for the temperature of the contents of the build module to be controlled, even when outside of the fabrication system. This may be advantageous both in allowing hot material within the build module to cool at controlled rates and in allowing cool material within the build module to be “preheated” prior to introduction into the fabrication system. In some embodiments, such build modules may be inserted into external devices providing power and control over the heating and cooling process as well as the motion systems. In other embodiments, a build module may have the necessary control systems integrated into the build module, such that it may simply be powered from standard sources without requiring a separate external device to regulate the heating or cooling process. In the example of FIG. 2A, the build module 201 includes a power connection 211.

FIG. 2B depicts one illustrative technique for connecting a build module to a fabrication system. As shown, the build module 201 may include a rail system 220, such that the build module may slide into a selective laser sintering apparatus and thereby become affixed to said apparatus. Such a rail system advantageously supports the build module along the length of the rail while limiting the range of motion of the build module. Alternatively, or in addition, other connectors such as spring connectors, ball locks, locking feet, clamps, or other mechanical mechanisms may be utilized. In general, the inventors have found it to be advantageous to include one or more connection points 221 to produce planar alignment of the build module within the selective laser sintering apparatus. These connection points 221 may be useful to provide precise angular and translational location information as well as ensuring the build module remains in place for the duration of the build process. FIG. 2B is provided by way of example and by no means represents the only method for providing a reliable connection that limits motion and allows for repeated exchanges without calibration.

According to some embodiments, connection points 221 may include any number of connectors or systems for sensing insertion and placement now known or later developed, such as pins/sockets, magnet connectors, and/or any other kind of mechanical locking mechanism. In some embodiments, there may be an advantage to include at least three connection points as shown in FIG. 2B, since mechanical attachment of the build module to the remainder of the additive fabrication device at at least three points may enable orientation of the build module in a stable, known, configuration.

According to some embodiments, in addition to the mechanical connections, sources of motion and sensors located within a build module may be connected to energy and control systems located within the fabrication system via the connection points 221. In the case of electrically driven motors, such as steppers, for example, electrical current may be provided via the connection points to the removable module to drive the rotation of the motor. Alternatively, or in addition, signals to and from various control mechanisms within the fabrication system may be transmitted to and from motors and other mechanisms within the build module via the connection points 221. For example, heating systems comprising heaters 111, temperature sensors, and/or other features may require power and/or control signals to be transmitted to and from the fabrication system into the build module via the connection points 221.

In some embodiments, signals and power flows may be transmitted along one or more cables suitable for such transmission extending between one or more points within the build module and one or more points within the fabrication system. Advantageously, the number of such connections may be minimized in order to avoid user interaction and potential error, such as by bundling individual cables into composite plugs or other similar devices. In other embodiments, however, the connection process may be further enhanced by incorporating the process of mechanical and transmission connection into an integrated process. Such connections may be achieved in various ways, including spring-loaded contact points, wireless transmission, or other methods. In some embodiments, such transmission connections may be used in order to confirm the secure mechanical connection of the build module, to communicate the presence or absence of the build module, or to communicate various characteristics of the build module, such as a unique identifier, model identifier, build module calibration settings, and/or other information about the module.

In some embodiments, aspects of the present invention may advantageously allow for improved post processing of the object, including removal of unconsolidated powder cake surrounding said object. For instance, it may be desirable to utilize various forms of mechanical assistance in removing the object from the build chamber and surrounding powder as part of the post processing steps, including removing unused powder from the build chamber for potential reuse, recycling, or disposal. Further, it may be desirable to allow for a period of controlled thermal processing, such as cooling to ambient temperatures at a controlled rate, following the completion of the sintering process exposing the powder to focused energy. As a result, in some embodiments the build chamber may be removable from the system such that the fabrication system can be utilized for additional fabrication steps while further processing on a fabricated object is completed. In particular, it may be advantageous to reverse the motion of the fabrication platform, described above, in order to remove the fabricated object and any unused material from the build chamber.

Embodiments of the present invention including one or more sources of motion within the build module may advantageously allow for the piston to be moved during a removal and depowdering process, even once the build module has been removed from the fabrication system. In such cases, an additional apparatus to support the build module and assist with the depowdering process may be provided, without duplication of any electromotive means or other sources of motion within the assisting apparatus. Rather, the build module may be connected to such a processing station through a mechanical and transmission connection, including using any of the techniques described above, and the components of the build module then used for post-processing. Similarly, in embodiments of the invention wherein one or more heating elements 209 and/or temperature sensor 210 are disposed within the removable build module, said elements may be advantageously reused by an additional post-fabrication apparatus to monitor, maintain, and control the temperature as desired. Alternatively, control means for such heating elements 209 may be disposed within the build module so as to utilize temperature sensors 210, thus forming a self-contained unit needing only an energy source, such as attachment to standard electrical sources, to allow for post-fabrication cool down to be accomplished without the need for any additional apparatus. Such a configuration may be particularly advantageous when multiple such build modules may require such processing. In some embodiments of this aspect of the invention, build chambers may be configured to include one or more wired or wireless communication devices, and/or indicating lights, sounds, or other signals, such that the status of the build module may be monitored and any desired process settings or parameters altered by external and/or remote devices.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A removable build module for an additive fabrication device configured to fabricate objects by forming layers of solid material from a source material, the removable build module comprising:
an enclosure having an open top;
a fabrication platform arranged in an interior of the enclosure; and
at least one actuator incorporated into the enclosure and configured to move the fabrication platform towards and away from the open top of the enclosure.

2. The removable build module of claim 1, further comprising a leadscrew and wherein the at least one actuator includes a source of rotational motion coupled to the leadscrew.

3. The removable build module of claim 1, further comprising at least one heater.

4. The removable build module of claim 1, further comprising at least one temperature sensor.

5. The removable build module of claim 4, further comprising:
at least one heater; and
at least one controller configured to adjust an amount of heat produced by the at least one heater based at least in part on an indication of temperature produced by the at least one temperature sensor.

6. The removable build module of claim 1, further comprising one or more sensors configured to generate an indication of the fabrication platform's position.

7. The removable build module of claim 1, further comprising one or more rails attached to an exterior of the enclosure.

8. The removable build module of claim 1, further comprising one or more connection points that include an opening through the enclosure.

9. The removable build module of claim 8, wherein at least a first connection point of the one or more connection points includes an electrical connector coupled to at least one electrical component of the removable build module.

10. The removable build module of claim 1, wherein the fabrication platform includes a planar upper surface extending across the interior of the enclosure.

11. The removable build module of claim 1, further comprising one or more guide rails arranged to guide the fabrication platform as the fabrication platform moves towards and away from the open top of the enclosure.
